(19) United States
(12) Patent Application Publication
(10) Pub. No.: US 2011/0106439 A1
(43) Pub. Date: May 5, 2011

(54) Method of displaying multiple points of interest on a personal navigation device

(76) Inventors: In-Tai Huang, Auckland (NZ); Takuya Otani, Auckland (NZ)

(21) Appl. No.: 12/612,655

(22) Filed: Nov. 4, 2009

(51) Int. Cl. G01C 21/00; G06F 3/041; G06F 3/048

(52) U.S. Cl. 701/208; 345/173; 715/828; 715/810

(57) ABSTRACT

A method of displaying points of interest in a personal navigation device includes displaying a map on a display of the personal navigation device, receiving touch input at a touched position of the display, searching an area within a search radius of the touched position for points of interest, displaying points of interest located in the area within the search radius, wherein the found points of interest are represented by icons connected to their locations on the map with a line extending out from the touched position, spreading out the icons around the touched position to separate the icons from each other, and gradually increasing the search radius to create an enlarged area within the increased search radius and displaying additional icons corresponding to points of interest located in the enlarged area.

### BACKGROUND OF THE INVENTION

1. Field of the Invention

The invention relates to a method of displaying multiple points of interest on a personal navigation device, and more particularly, to a method for spreading out closely located points of interest to create a flower shape surrounding a selected position.

2. Description of the Prior Art

Global Positioning System (GPS) based navigation devices are well known and are widely employed as in-car navigation devices. Common functions of a navigation device include providing a map database for generating navigation instructions that are then shown on a display of the navigation device. These navigation devices are often mounted on or in the dashboard of a vehicle using a suction mount or other mounting means.

The term “navigation device” refers to a device that enables a user to navigate to a pre-defined destination. The device may have an internal system for receiving location data, such as a GPS receiver, or may merely be connectable to a receiver that can receive location data. The device may compute a route itself, or communicate with a remote server that computes the route and provides navigation information to the device, or a hybrid device in which the device itself and a remote server both play a role in the route computation process. Personal GPS navigation devices are not permanently integrated into a vehicle but instead are devices that can readily be mounted in or otherwise used inside a vehicle. Generally (but not necessarily), they are fully self-contained—i.e. include an internal GPS antenna, navigation software and maps and can hence plot and display a route to be taken.

One useful feature of personal navigation devices is the ability to list nearby points of interest. In rural areas, points of interest may be spread out far from each other, and can easily be shown on the display of the personal navigation device. However, when traveling through cities or other areas where there are many points of interest in close proximity to one another, there can be tens of points of interest located very close together.

Please refer to FIG. 11. FIG. 11 illustrates a map 400 containing many icons representing points of interest 402 in a small area. If a user wishes to select a point of interest for either finding out more information about it or for receiving navigation instructions to the point of interest, this can be difficult to do if there are many icons clustered together. As an example, area 404 on the map 400 has many points of interest 402 grouped nearby one another, making it difficult for a user to distinguish among the points of interest located in area 404.

From the above, it can be seen that it is difficult to clearly show multiple points of interest that are in very close proximity to each other on the display of a personal navigation device. To deal with this problem, the prior art has used several different approaches for presenting information about points of interest to users of personal navigation devices.

One method used in the prior art is assigning different priority levels to different types of points of interest. For instance, an office building can be given a low priority while a hospital or a tourist attraction can be given higher priority. Once the priority levels have been established, the personal navigation device can be set to only display points of interest having a priority level equal or greater than a minimum priority. Otherwise, if there are still many points of interest meeting the minimum priority level, the personal navigation device will display only the points of interest with the greatest priority level.

One problem with the traditional approach to displaying points of interest is that if several points of interest occur at the same location or nearby locations, only one type of point of interest icon is drawn, which will be the icon representing the point of interest having the highest priority level. Another related problem is if a point of interest has been selected as a target destination for a user's trip, it is still not shown on the map if this type of point of interest was not enabled or not given high enough priority.

In addition, it is not often possible for users to narrow down categories to a finer granularity of point of interest types, such as selecting curry houses within the restaurant category, or selecting specific chains such as Starbucks™ within the coffee shop category.

Other problems come when the areas displayed on the map change when a user continues driving. As the map point of view changes, points of interest will appear and disappear from the map as their relative positions and priorities vary over time. Having icons constantly appear and disappear can be distracting to users.

Many personal navigation device manufacturers include more points of interest on a map than necessary for the average user because they want the user to appreciate all of the points of interest that the personal navigation device displays. However, most of the time, users are not interested in many of these points of interest. For example, restaurants, Automated Teller Machines (ATMs), etc. are only of interest when you need them, and are not required for every day driving.

After points of interest are displayed on the map, the user may find out more information about one of the points of interest by selecting it. However, if the point of interest that they are interested in is not shown as one of the displayed types of points of interest, they do not have this option. Instead, they may need to zoom in and move the map around in order to display the point of interest that they know is enabled. This may cause confusion as to why they are not able to find the specific point of interest on the map when they know that the point of interest is actually there.

Another problem comes when the user touches a map at a specific location containing multiple points of interest. In this case, the personal navigation device cannot tell which point of interest the user is interested in, and cannot show them the correct location details.

### SUMMARY OF THE INVENTION

It is therefore one of the primary objectives of the claimed invention to provide a method for displaying points of interest on a personal navigation device in order to clearly display multiple points of interest that are located within a selected search area.

According to an exemplary embodiment of the claimed invention, a method of displaying points of interest in a personal navigation device is disclosed. The method includes displaying a map on a display of the personal navigation device, receiving touch input at a touched position of the display, searching an area within a search radius of the touched position for points of interest, displaying points of interest located in the area within the search radius, wherein the found points of interest are represented by icons connected to their locations on the map with a line extending out from the touched position, spreading out the icons around the touched position to separate the icons from each other, and gradually increasing the search radius to create an enlarged area within the increased search radius and displaying additional icons corresponding to points of interest located in the enlarged area.

According to another exemplary embodiment of the claimed invention, a personal navigation device for displaying multiple points of interest located in close proximity to one another is disclosed. The personal navigation device includes a memory for storing a map database and a plurality of points of interest; a touch-sensitive screen for displaying a map and for receiving touch input at a touched position of the touch-sensitive screen; and a processor for searching an area within a search radius of the touched position for points of interest, displaying points of interest located in the area within the search radius, wherein the found points of interest are represented by icons connected to their locations on the map with a line extending out from the touched position, spreading out the icons around the touched position to separate the icons from each other, and gradually increasing the search radius to create an enlarged area within the increased search radius and displaying additional icons corresponding to points of interest located in the enlarged area.

It is an advantage that the present invention provides a clear way to display multiple points of interest, even when the points of interest are located in very close proximity to each other. Icons representing the points of interest will automatically spread out so that the points of interest located within the search radius can easily be seen.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a personal navigation device according to the present invention.

FIG. 2 illustrates a map showing roads and points of interest.

FIG. 3 illustrates another map showing a search for points of interest within a radius of a touched position of the map.

FIGS. 4-10 show maps displaying points of interest located nearby a touched position.

FIG. 11 illustrates a map containing many icons representing points of interest in a small area.

### DETAILED DESCRIPTION

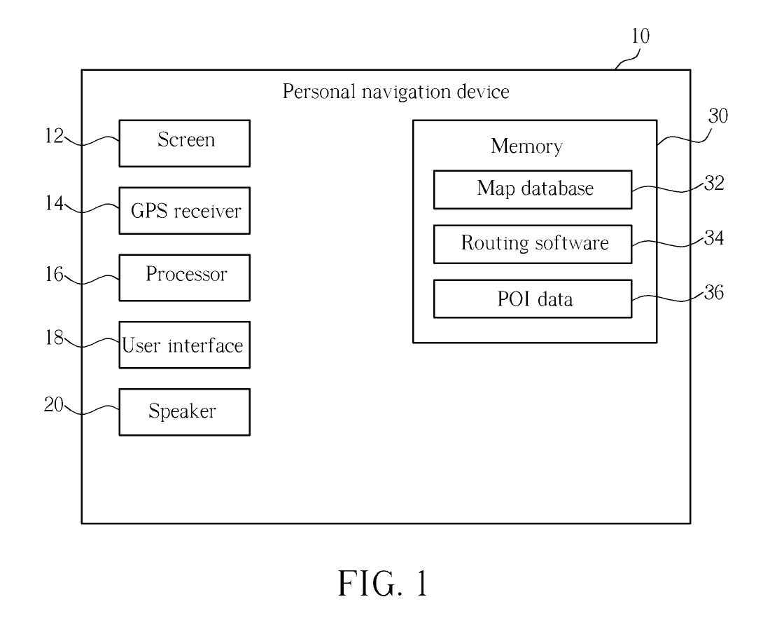

Please refer to FIG. 1. FIG. 1 is a block diagram of a personal navigation device 10 according to the present invention. The personal navigation device 10 contains a screen 12 which can be a touch-sensitive screen, a GPS receiver 14 for receiving the current coordinates of the personal navigation device 10, a processor 16 for controlling operation of the personal navigation device 10, a user interface 18, a speaker 20, and memory 30. The memory 30 is used to store a map database 32 containing map data and points of interest. The memory 30 also stores routing software 34 and point of interest data 36.

The point of interest data 36 stores a plurality of points of interest, and each point of interest may have at least one corresponding point of interest category label. Common category labels include “gas station”, “restaurant”, “hotel”, “bank”, and so on. To make it easier to identify the different categories of points of interest, each category may also have its own unique icon such as a dollar sign “$” for a bank.

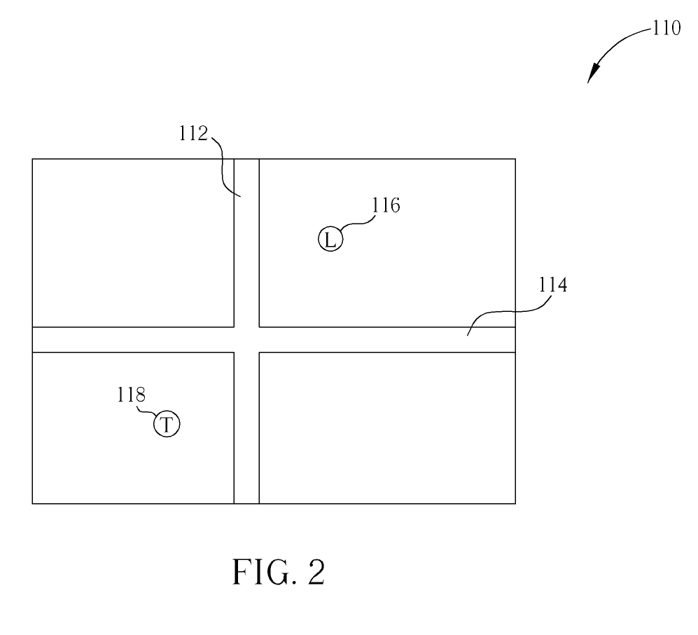

Please refer to FIG. 2. FIG. 2 illustrates a map 110 showing roads 112 and 114 and points of interest 116 and 118. Point of interest 116 corresponds to a landmark, whereas point of interest 118 corresponds to a tourist attraction. If the user wishes to find out more information about either of the points of interest 116 and 118, the user can touch or select one of them to see additional information. If the user touches a portion of the map 110 that does not have any points of interest shown, a search can be performed for nearby points of interest. The present invention only requires the user to touch the screen 12 on which the map 110 is displayed. It is not necessary to use a mouse or other pointing device to move a cursor to a desired position.

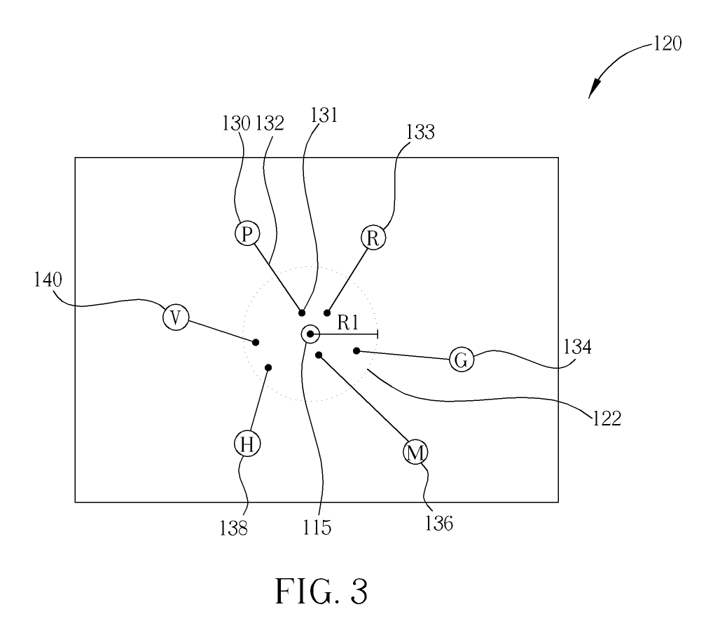

Please refer to FIG. 3. FIG. 3 illustrates another map 120 showing a search for points of interest within a radius R1 of a touched position 115 of the map 120. Before the user touches the screen 12 at the touched position 115, some or perhaps all of the points of interest can be hidden from view on the map 120. By not displaying the points of interest on the map 120 initially, the map 120 is kept less cluttered for enhancing the readability of the map 120. Extra points of interest appearing on the map 120 may prove to be unnecessary distractions while the user is driving. If the user wishes to see points of interest located around an area, all the user needs to do is touch the screen 12 any position, which is defined as the touched position 115.

When the user touches the touched position 115, an area 122 within the radius R1 is searched for points of interest located within the area 122. If several points of interest are found within the area 122, each point of interest is represented as an icon attached to its location point by a line. Icon 130 represents a parking lot located at location point 131. Icon 130 is attached to location point 131 by line 132. Other similar icons are also shown in FIG. 3, including icon 133 representing a restaurant, icon 134 representing a golf course, icon 136 representing a museum, icon 138 representing a hospital, and icon 140 representing a visitor's center. Although each of the icons 130, 133, 134, 136, 138, 140 has a corresponding location point and line connecting the icon to the location point, only the location point 131 and line 132 corresponding to icon 130 are numbered for enhancing the clarity of FIG. 3.

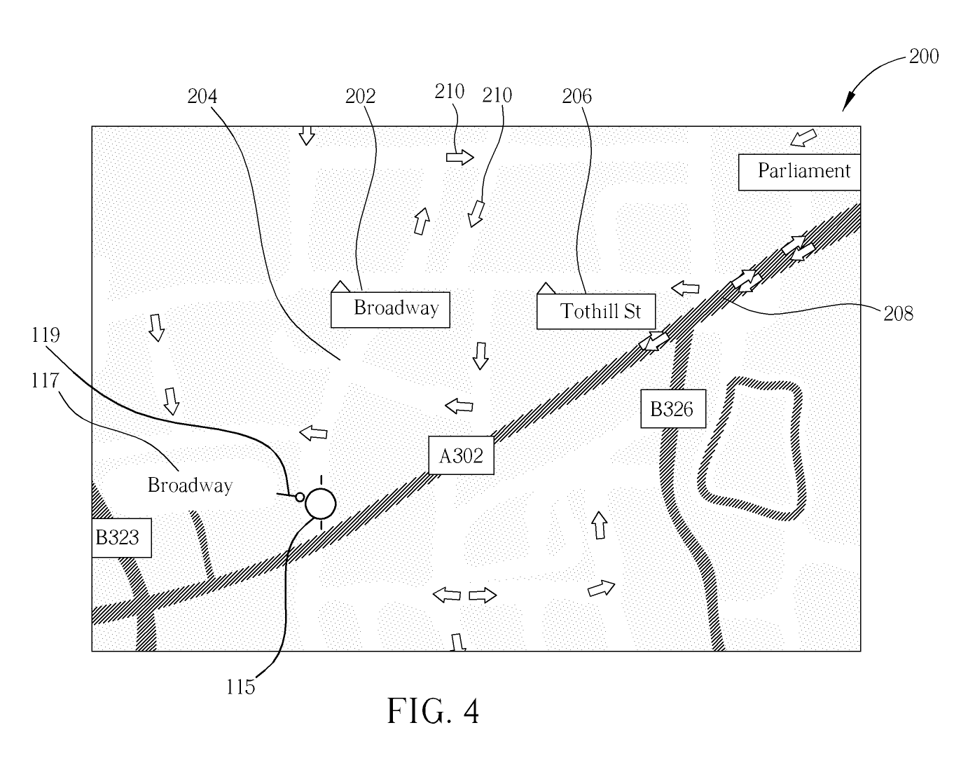

Please refer to FIG. 4. FIG. 4 shows a map 200 which the user touches at the touched position 115. Before the user touches the map 200, the map shows numerous roads and road labels. For instance road 204 has a corresponding road label 202 stating that the road's name is “Broadway”. Similarly, road 208 has a road label 206 stating that the name of the road is “Tothill St”. Other labels can also be used such as one-way road indicators 210 that help a user to identify which roads are one-way roads. After the user touches the screen 12 on which the map 200 is displayed at the touched position 115, a label 117 appears having a line 119 drawn between the label 117 and the touched position 115. A cursor appears at the touched position 115, thereby indicating on the map where the user touched the screen 12. The cursor is shown here as a small circle although other shapes may be used instead. The label 117 shows the name of the location nearest to the touched position 115 that is navigatable. After the user touches the screen 12 at the touched position 115, a region around the touched position 115 is searched for nearby points of interest.

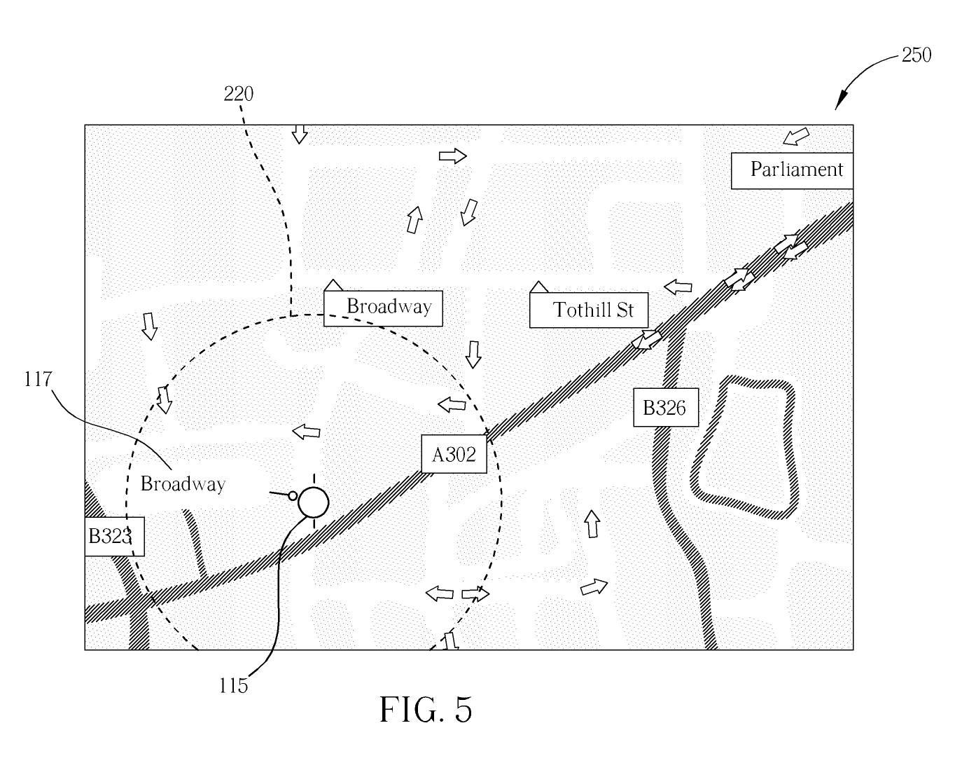

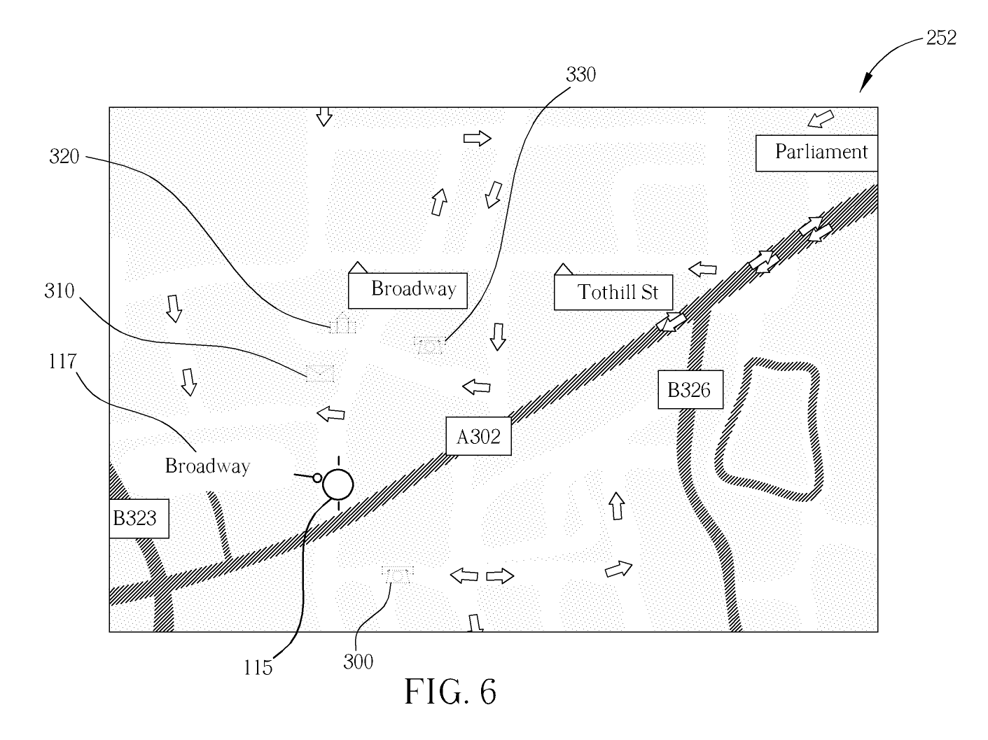

Please refer to FIGS. 5-10. FIG. 5 shows a map 250 showing an area 220 within a search radius that is used for searching for points of interest located within the area 220. Once found, the points of interest will gradually fade into view on the map 250. FIG. 6 shows a map 252 showing icons 300, 310, 320, 330 representing points of interest starting to appear on the map 252. As more time passes, the icons 300, 310, 320, 330 will fade in and become more visible and the icons may shift positions to maintain a predetermined distance between themselves. At the same time, the search radius gradually increases until the radius reaches a predetermined maximum distance. If a user touches an icon representing a point of interest on the screen 12, in some embodiments the received touch input will stop the search radius from increasing and will also stop additional icons from being displayed on the screen 12. The user will then be presented with additional information about the selected point of interest.

In some embodiments, the predetermined maximum distance may be disregarded, and the radius may increase to the point where the whole map 250 is included in the area 220. In other embodiments, the predetermined maximum distance may vary according to the urban density of the location that the personal navigation device 10 is currently located in. For example, the maximum distance can be increased for allowing a wider search when the personal navigation device 10 is located in rural or suburban areas. On the other hand, a shorter maximum distance can be used for narrowing a search area when the personal navigation device 10 is located in urban city areas. Furthermore, the user can customize the maximum distance for each different type of situation.

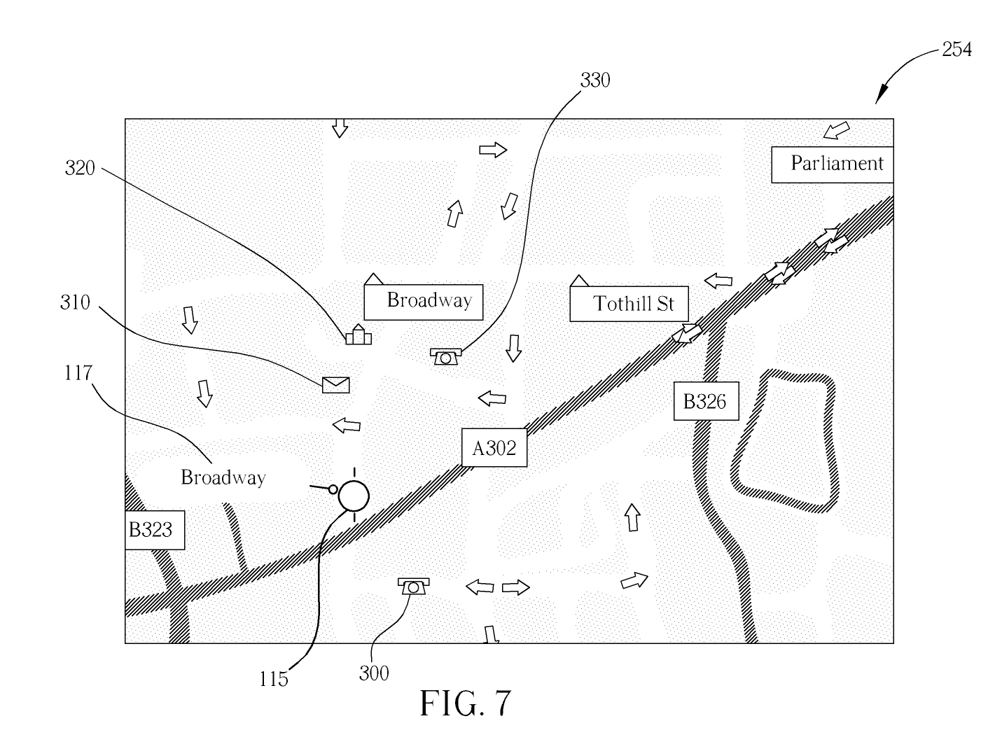

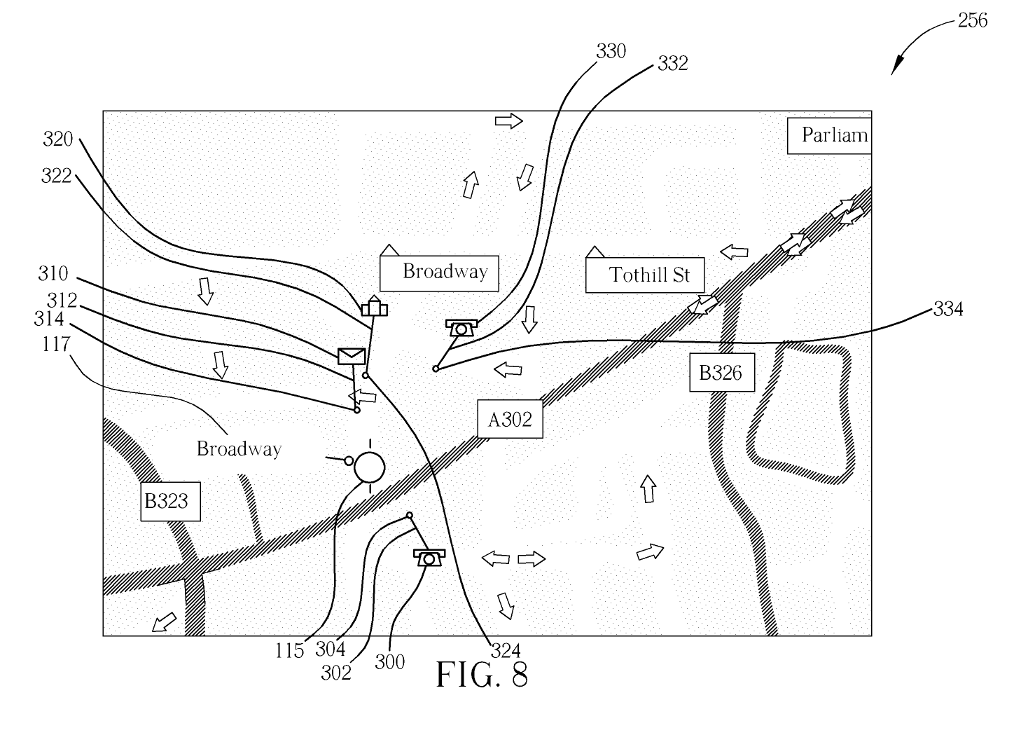

FIG. 7 shows a map 254 in which the icons 300, 310, 320, 330 continue to fade in and begin shifting positions to avoid one another. From comparing map 252 of FIG. 6 with map 254 of FIG. 7, it can be seen that icons 310, 320, 330 have already begun to separate from each other. FIG. 8 shows a map 256 in which the icons 300, 310, 320, 330 have come into full view and are connected to their actual locations 304, 314, 324, 334 on the map 256 with lines 302, 312, 322, 332, respectively. Notice that icon 310 is currently shown as being very close to line 322. Therefore, the icons 300, 310, 320, 330 will shift positions so that none of the icons 300, 310, 320, 330 or lines 302, 312, 322, 332 intersect, overlap, or come within a predetermined distance of one another. In this particular case, one or both of the icons 310, 320 will shift positions to maintain a predetermined distance between icon 310 and line 322. Icons may move in any direction, and will generally move out radially from the touched position 115 and/or move tangentially or sideways.

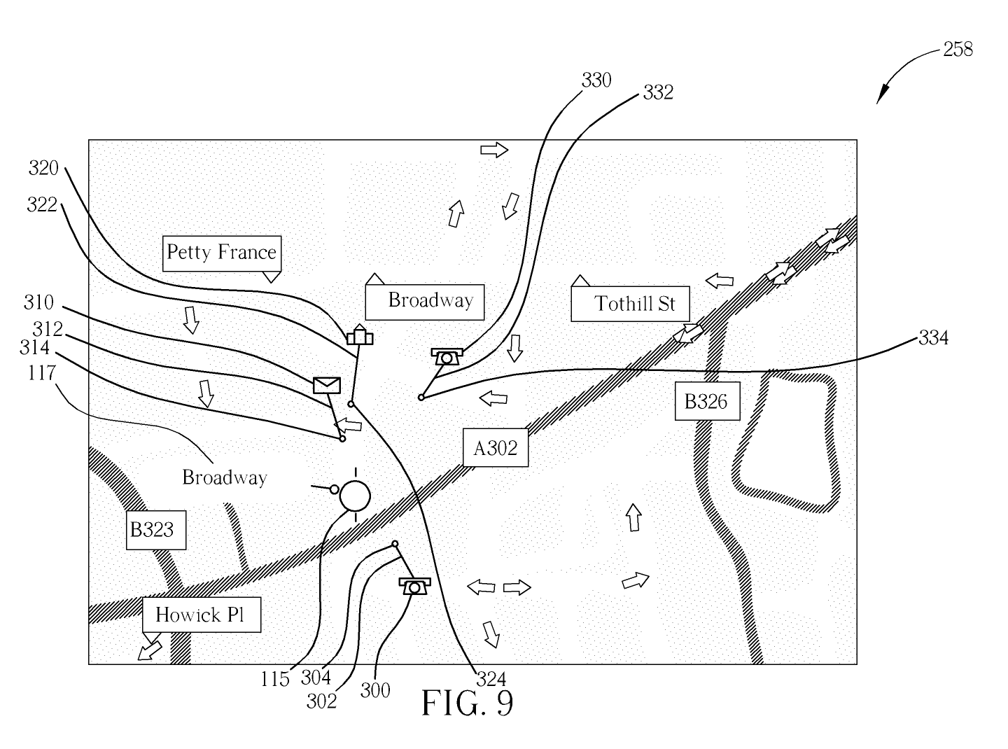

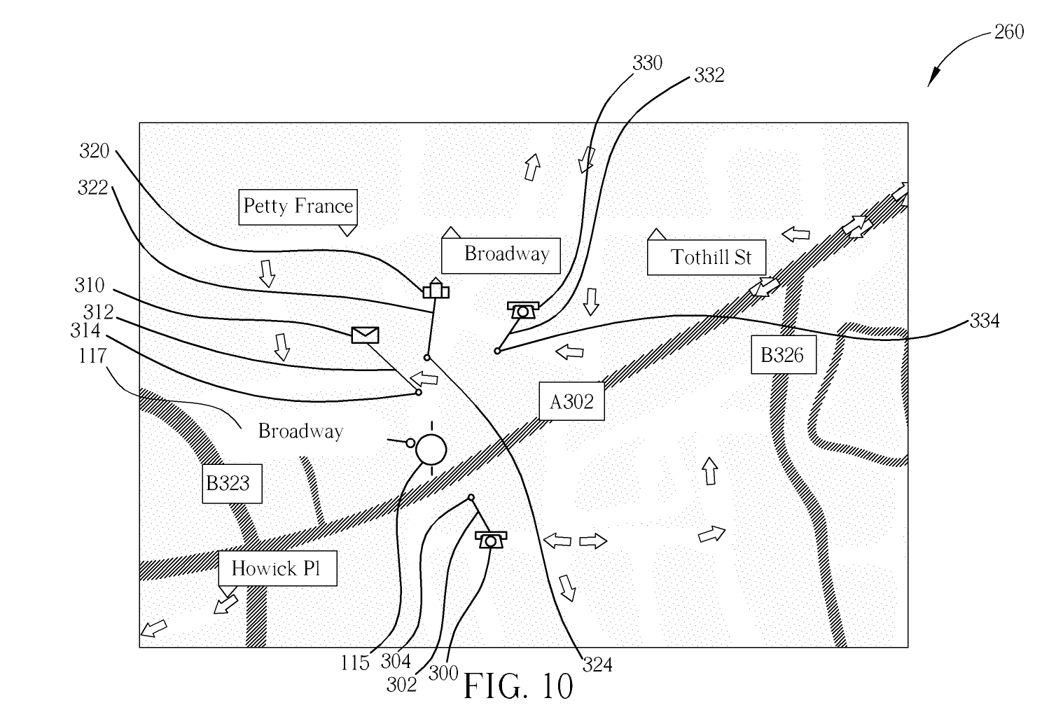

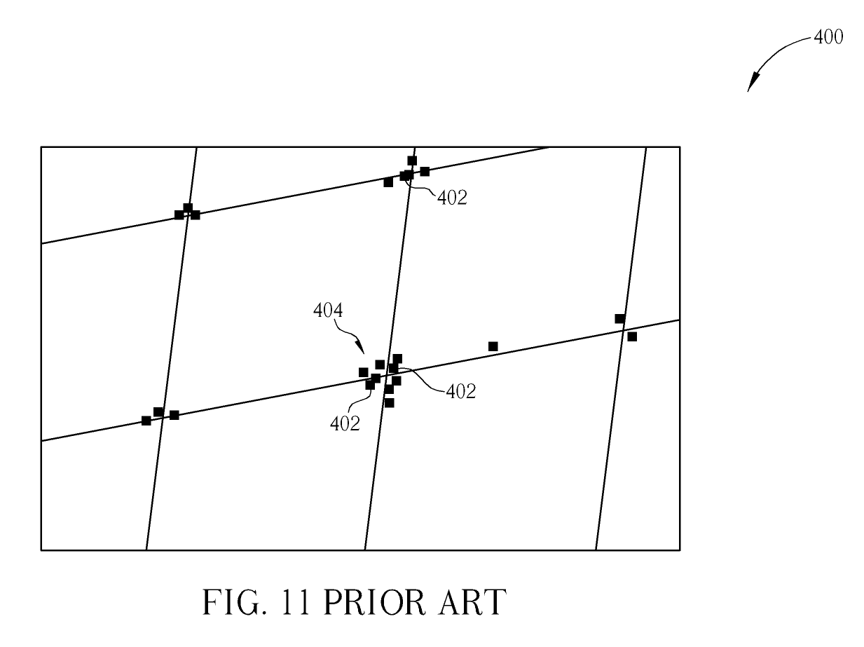

FIG. 9 shows a map 258 in which icon 310 continues to move away from line 322. FIG. 10 shows a map 260 showing the final position of the icons 300, 310, 320, 330 after the icons have shifted positions to separate themselves and maintain a predetermined distance between themselves. In general, once icons appear on a map, the icons will move away from one another if the icons or the lines connecting the icons to their actual locations on the map are within a predetermined threshold of one another. Collisions or intersections between lines is also to be avoided. The intersection between two lines connecting icons to their actually locations on the map can be remedied by shifting the corresponding icons away from one another or by swapping the positions of the icons and redrawing the lines connecting the icons to their actual positions on the map.

After a predetermined period of time has elapsed since touch input was received at the touched position 115, the icons will disappear from view. The icons can disappear gradually or immediately. If the user has clicked on one of the icons before the icons disappear, the user can be presented with additional information about the point of interest that the icon represents. If the user has clicked on another part of the display that does not contain an icon, then in some embodiments all of the icons will disappear to allow the user to see a clearer screen.

In summary, the present invention provides a clear way to display multiple points of interest, even when the points of interest are located in very close proximity to each other. Icons representing the points of interest will gradually fade into view and will automatically separate from each other so that the points of interest located within the search radius can easily be seen.

Those skilled in the art will readily observe that numerous modifications and alterations of the device and method may be made while retaining the teachings of the invention.

What is claimed is:

1. A method of displaying points of interest in a personal navigation device, the method comprising:
displaying a map on a display of the personal navigation device;
receiving touch input at a touched position of the display;
searching an area within a search radius of the touched position for points of interest;
displaying points of interest located in the area within the search radius, wherein the found points of interest are represented by icons connected to their locations on the map with a line extending out from the touched position;
spreading out the icons around the touched position to separate the icons from each other; and
gradually increasing the search radius to create an enlarged area within the increased search radius and displaying additional icons corresponding to points of interest located in the enlarged area.

2. The method of claim 1 further comprising stopping displaying additional icons when the search radius is greater than an upper threshold.

3. The method of claim 1 further comprising displaying icons only for a predetermined time period after the touch input is received.

4. The method of claim 1 further comprising stopping displaying the icons when receiving touch input at another point of the display.

5. The method of claim 1, wherein positions of icons shift to maintain a minimum separation distance between icons, between lines that connect icons to their respective locations on the map, and between icons and lines that connect other icons to their respective locations on the map.

6. The method of claim 5, wherein the icons shift outward radially and increase the length of the lines connecting the icons to their respective locations on the map.

7. The method of claim 5, wherein the icons shift tangentially for maintaining the length of the lines connecting the icons to their respective locations on the map.

8. The method of claim 1 further comprising displaying a label indicating a location at the touched position.

9. The method of claim 1 further comprising
receiving touch input directed to a displayed icon; and
displaying additional information about the point of interest corresponding to the displayed icon for which touch input has been received.

10. The method of claim 1, wherein different icons are used to represent different types of points of interest.

11. A personal navigation device for displaying multiple points of interest located in close proximity to one another, comprising:
a memory for storing a map database and a plurality of points of interest;
a touch-sensitive screen for displaying a map and for receiving touch input at a touched position of the touch-sensitive screen; and
a processor for searching an area within a search radius of the touched position for points of interest, displaying points of interest located in the area within the search radius, wherein the found points of interest are represented by icons connected to their locations on the map with a line extending out from the touched position, spreading out the icons around the touched position to separate the icons from each other, and gradually increasing the search radius to create an enlarged area within the increased search radius and displaying additional icons corresponding to points of interest located in the enlarged area.

12. The personal navigation device of claim 11, wherein the processor stops displaying additional icons when the search radius is greater than an upper threshold.

13. The personal navigation device of claim 11, wherein the processor displays icons only for a predetermined time period after the touch input is received.

14. The personal navigation device of claim 11, wherein the processor stops displaying the icons when receiving touch input at another point of the touch-sensitive screen.

15. The personal navigation device of claim 11, wherein the processor shifts positions of icons to maintain a minimum separation distance between icons, between lines that connect icons to their respective locations on the map, and between icons and lines that connect other icons to their respective locations on the map.

16. The personal navigation device of claim 15, wherein the icons shift outward radially and increase the length of the lines connecting the icons to their respective locations on the map.

17. The personal navigation device of claim 15, wherein the icons shift tangentially for maintaining the length of the lines connecting the icons to their respective locations on the map.

18. The personal navigation device of claim 11, wherein the processor controls the touch-sensitive screen to display a label indicating a location at the touched position.

19. The personal navigation device of claim 11, wherein in response to receiving touch input directed to a displayed icon, the processor controls the touch-sensitive screen to display additional information about the point of interest corresponding to the displayed icon for which touch input has been received.

20. The personal navigation device of claim 11, wherein different icons are used to represent different types of points of interest.
